(19) United States
(12) Patent Application Publication
(10) Pub. No.: US 2011/0208342 A1
(43) Pub. Date: Aug. 25, 2011

(54) Inspection Method and Apparatus, and Lithographic Apparatus

(75) Inventors: Arie Jeffrey Den Boef, Waalre (NL); Johannes Maria Kuiper, Koog aan de Zaan (NL)

(73) Assignee: ASML NETHERLANDS B.V.

(21) Appl. No.: 13/055,851

(22) PCT Filed: Jul. 21, 2009
(86) PCT No.: PCT/EP2009/059362

§ 371 Date: Apr. 15, 2011

Related U.S. Application Data
(60) Provisional application No. 61/090,732, filed on Aug. 21, 2008.

(51) Int. Cl. G06F 19/00

(52) U.S. Cl. 700/109

(57) ABSTRACT

A metrology device for inspecting a substrate is provided. In an embodiment, the metrology device includes a remote radiation source device, an optical system for creating a radiation beam, and an optical fibre for transferring radiation from the optical system to the location where the metrology operations are performed. The optical system includes a control system that includes a deformable mirror, a detector that detects the position of a radiation beam, and a controller that produces a control signal for input into the deformable mirror, the control signal being based on the detected position of the radiation. In this way, the shape of the deformable mirror can be used to control the position of the radiation beam output by the optical system into the optical fibre.

### CROSS-REFERENCE TO RELATED APPLICATIONS

This application claims the benefit of U.S. provisional application 61/090,732, which was filed on Aug. 21, 2008, and which is incorporated herein in its entirety by reference.

### BACKGROUND

1. Field

Embodiments of the present invention relate to methods of inspection usable, for example, in the manufacture of devices by lithographic techniques and to methods of manufacturing devices using lithographic techniques.

2. Background

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (e.g., resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to monitor the lithographic process, it is necessary to measure parameters of the patterned substrate, for example the overlay error between successive layers formed in or on it. There are various techniques for making measurements of the microscopic structures formed in lithographic processes, including the use of scanning electron microscopes and various specialized tools. One form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle.

The radiation sources that are normally used to produce radiation for the inspection/measurement processes generate a substantial amount of heat. The heat may affect the measurement processes, and so the radiation source is typically separated from the measurement sensors. An optical fibre may be used to transfer radiation from a radiation source to the position where it is required for the inspection/measurement process.

However, the radiation emitted from the radiation source can exhibit poor positional stability (for example due to sputtering from electrodes). This can lead to fluctuations in the position of a resulting radiation beam. These variations in position of the radiation beam at entry to the optical fibre can lead to variations in the properties (such as intensity and/or uniformity) of the radiation that exits the optical fibre. In other words, the coupling efficiency of the radiation beam into the optical fibre can vary over time. In turn, this can adversely affect the inspection/measurement process for which the radiation beam is being used.

### BRIEF SUMMARY

Given the foregoing, what is needed is an apparatus for providing a stable radiation beam for use in inspecting a substrate.

According to an aspect of the invention, there is provided an inspection apparatus, lithographic apparatus or lithographic cell configured to measure a property of a substrate.

According to an aspect of the invention, there is provided a metrology device for inspecting a substrate. The metrology device includes a radiation source, an optical system configured to form a radiation beam from the radiation source. and an optical fibre configured to transfer the radiation beam from the output of the optical system to a substrate being inspected. In an embodiment, the optical system includes a control system to control the position of the radiation beam output therefrom relative to the optical fibre.

Also according to an aspect of the present invention there is provided a method of providing a radiation beam for inspecting a substrate. The method includes providing radiation from a radiation source, forming a radiation beam from the radiation using an optical system, transferring the radiation beam from an output of the optical system to a substrate to be inspected using an optical fibre, and controlling the position of the radiation beam at the output from the optical system relative to the optical fibre.

### BRIEF DESCRIPTION OF THE DRAWINGS/FIGURES

Embodiments of the invention will now be described, by way of example only, with reference to the accompanying schematic drawings in which corresponding reference symbols indicate corresponding parts, and in which:

FIG. 1 depicts a lithographic apparatus;

FIG. 2 depicts a lithographic cell or cluster;

FIG. 3 depicts a first scatterometer that may be used in an embodiment of the present invention;

FIG. 4 depicts a second scatterometer that may be used in an embodiment of the present invention;

FIG. 5 depicts a schematic showing features of a metrology device according to an embodiment of the present invention in which an optical fibre is used to transfer radiation from a remote source to a scatterometer; and

FIG. 6 depicts a device for supplying radiation for a metrology device according to an embodiment of the present invention.

### DETAILED DESCRIPTION

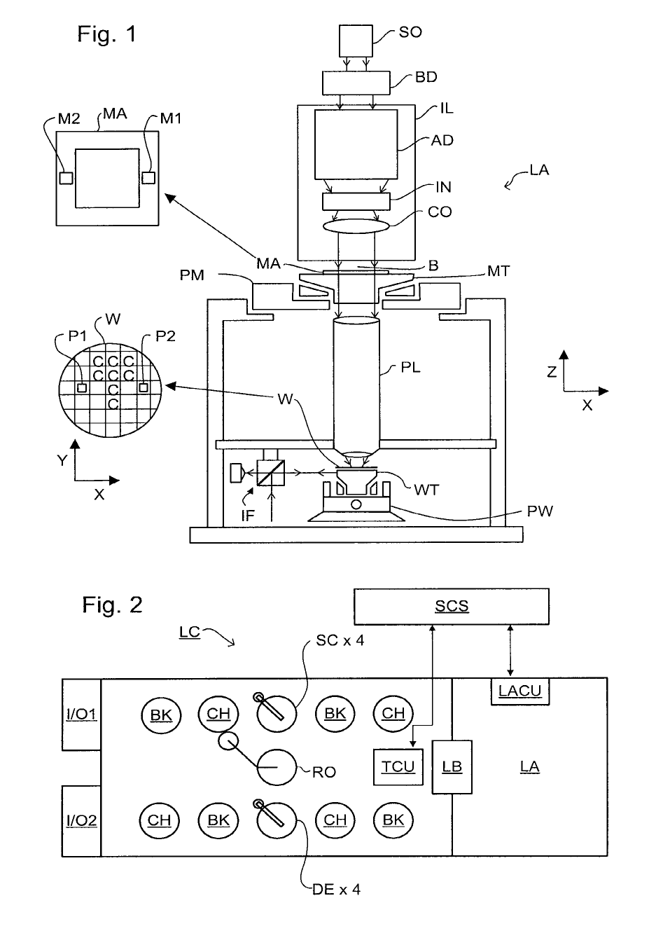

FIG. 1 schematically depicts a lithographic apparatus. The apparatus includes
an illumination system (illuminator) IL configured to condition a radiation beam B (e.g. UV radiation or DUV radiation);
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PL configured to project a pattern imparted to radiation beam B by patterning device MA onto a target portion C (e.g. including one or more dies) of substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from source SO to illuminator IL with the aid of a beam delivery system BD including, for example, suitable directing mirrors and/or a beam expander. In other cases the source may be an integral part of the lithographic apparatus, for example when the source is a mercury lamp. Source SO and illuminator IL, together with beam delivery system BD if required, may be referred to as a radiation system.

Illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, illuminator IL may include various other components, such as an integrator IN and a condenser CO. The illuminator may be used to condition the radiation beam to have a desired uniformity and intensity distribution in its cross-section.

Radiation beam B is incident on the patterning device (e.g., mask MA), which is held on the support structure (e.g., mask table MT), and is patterned by the patterning device. Having traversed mask MA, radiation beam B passes through projection system PL, which focuses the beam onto a target portion C of substrate W. With the aid of second positioner PW and position sensor IF (e.g. an interferometric device, linear encoder, 2-D encoder or capacitive sensor), substrate table WT can be moved accurately, e.g. so as to position different target portions C in the path of radiation beam B. Similarly, first positioner PM and another position sensor (which is not explicitly depicted in FIG. 1) can be used to accurately position mask MA with respect to the path of radiation beam B, e.g. after mechanical retrieval from a mask library, or during a scan. In general, movement of mask table MT may be realized with the aid of a long-stroke module (coarse positioning) and a short-stroke module (fine positioning), which form part of first positioner PM. Similarly, movement of substrate table WT may be realized using a long-stroke module and a short-stroke module, which form part of second positioner PW. In the case of a stepper (as opposed to a scanner) mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on mask MA, the mask alignment marks may be located between the dies.

The depicted apparatus could be used in at least one of the following modes:

1. In step mode, mask table MT and substrate table WT are kept essentially stationary, while an entire pattern imparted to the radiation beam is projected onto a target portion C at one time (i.e. a single static exposure). Substrate table WT is then shifted in the X and/or Y direction so that a different target portion C can be exposed. In step mode, the maximum size of the exposure field limits the size of target portion C imaged in a single static exposure.

2. In scan mode, mask table MT and substrate table WT are scanned synchronously while a pattern imparted to the radiation beam is projected onto a target portion C (i.e. a single dynamic exposure). The velocity and direction of substrate table WT relative to mask table MT may be determined by the (de-)magnification and image reversal characteristics of projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, mask table MT is kept essentially stationary holding a programmable patterning device, and substrate table WT is moved or scanned while a pattern imparted to the radiation beam is projected onto a target portion C. In this mode, generally a pulsed radiation source is employed and the programmable patterning device is updated as required after each movement of substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 2, lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded—thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into lithographic apparatus LA or lithocell LC or may be a stand-alone device. To enable most rapid measurements, it is desirable that the inspection apparatus measure properties in the exposed resist layer immediately after the exposure. However, the latent image in the resist has a very low contrast—there is only a very small difference in refractive index between the parts of the resist which have been exposed to radiation and those which have not—and not all inspection apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

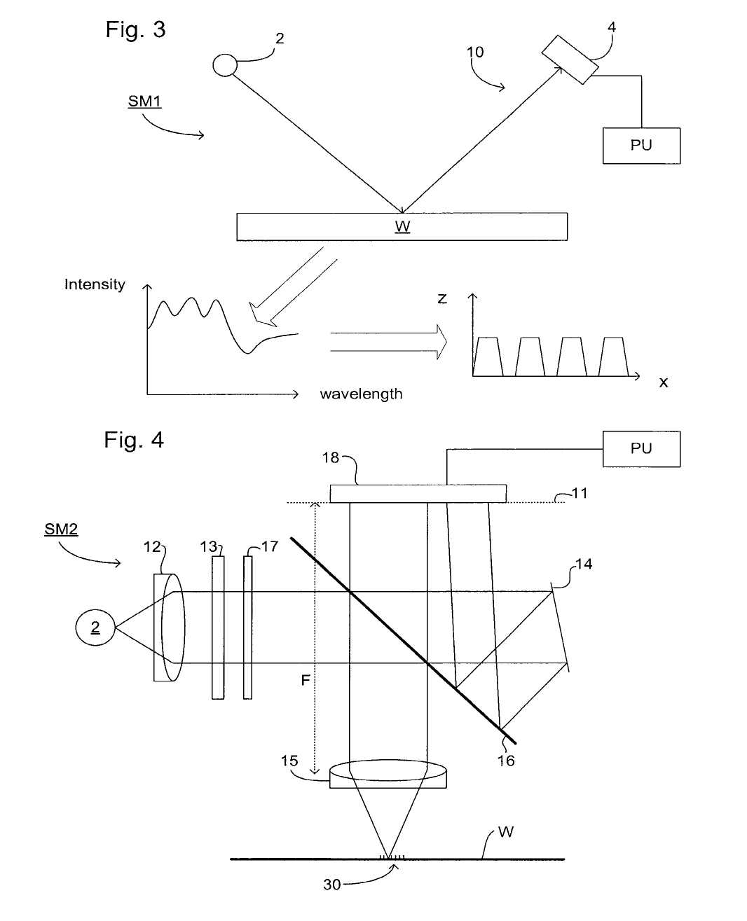

FIG. 3 depicts a scatterometer which may be used in an embodiment of the present invention. It comprises a broadband (white light) radiation projector 2 which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU, e.g. by Rigorous Coupled Wave Analysis and non-linear regression or by comparison with a library of simulated spectra as shown at the bottom of FIG. 3. In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer that may be used with embodiments of the present invention is shown in FIG. 4. In this device, the radiation emitted by radiation source 2 is collimated using lens system 12 through interference filter 13 and polarizer 17, reflected by partially reflective surface 16 and is focused onto substrate W via a microscope objective lens 15. In an embodiment, microscope objective lens 15 has a high numerical aperture (NA). In an embodiment, the NA is at least 0.9. In another embodiment, the NA is at least 0.95. Some scatterometers, such as immersion scatterometers, may even have lenses with numerical apertures over 1. The reflected radiation then transmits through partially reflective surface 16 into a detector 18 in order to have the scatter spectrum detected. The detector may be located in the back-projected pupil plane 11, which is at the focal length of lens system 15. However the pupil plane may instead be re-imaged with auxiliary optics (not shown) onto the detector. The pupil plane is the plane in which the radial position of radiation defines the angle of incidence and the angular position defines the azimuth angle of the radiation. In an embodiment, the detector is a two-dimensional detector so that a two-dimensional angular scatter spectrum of a substrate target 30 can be measured. Detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16, part of the radiation beam is transmitted through the beam splitter as a reference beam towards a reference mirror 14. The reference beam is then projected onto a different part of the same detector 18.

A set of interference filters 13 is available to select a wavelength of interest in the range of, say, 405-790 nm or even lower, such as 200-300 nm. The interference filter may be tunable rather than including a set of different filters. A grating may be used instead of interference filters.

Detector 18 may measure the intensity of scattered light at a single wavelength (or narrow wavelength range), the intensity separately at multiple wavelengths, or the intensity integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e. one with a wide range of light frequencies or wavelengths—and therefore of colors) is possible, which gives a large etendue, allowing the mixing of multiple wavelengths. In an embodiment, each wavelength in the plurality of wavelengths in the broadband has a bandwidth of *8 and a spacing of at least 2*8 (i.e. twice the bandwidth). Several “sources” of radiation can be different portions of an extended radiation source which have been split using fiber bundles. In this way, angle resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP 1,628,164A, incorporated herein by reference in its entirety.

Target 30 on substrate W may be a grating, which is printed such that after development, the bars are formed of solid resist lines. The bars may alternatively be etched into the substrate. This pattern is sensitive to chromatic aberrations in the lithographic projection apparatus, particularly projection system PL, and illumination symmetry and the presence of such aberrations will manifest themselves in a variation in the printed grating. Accordingly, the scatterometry data of the printed gratings is used to reconstruct the gratings. The parameters of the grating, such as line widths and shapes, may be input to the reconstruction process, performed by processing unit PU, from knowledge of the printing step and/or other scatterometry processes.

As explained herein, the source used to provide radiation for a scatterometer is often remote from the sensors and substrate W being measured/inspected. Optical fibres or bundles of optical fibres are typically used to transfer the radiation from the remote source to the position where it is required.

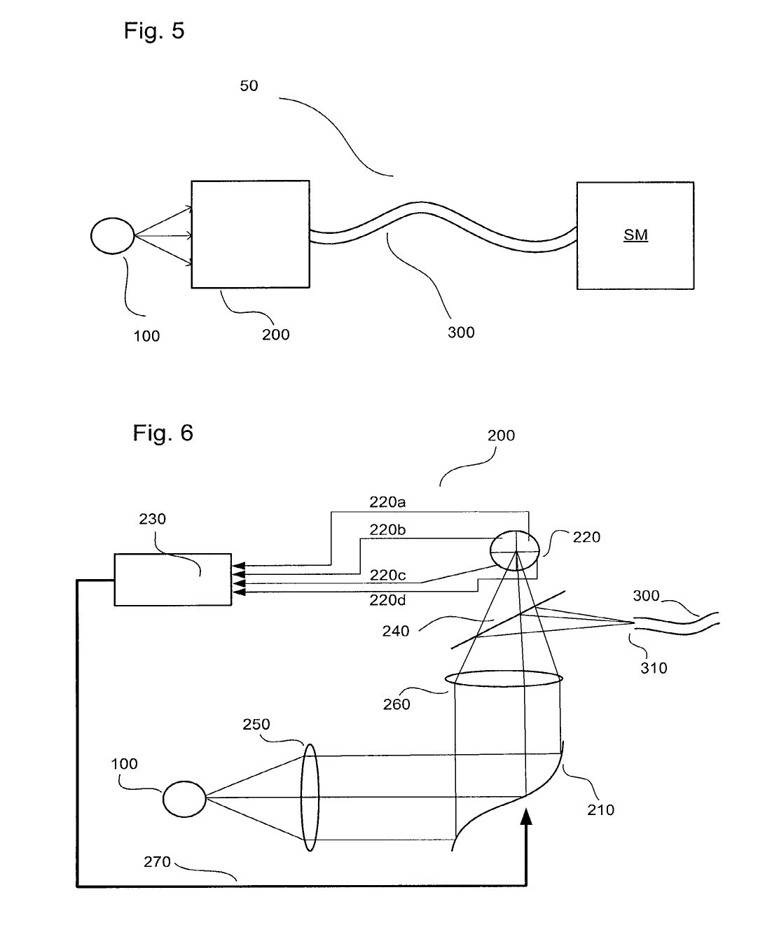

A schematic of a typical metrology device according to an aspect of the present invention is shown in FIG. 5. In FIG. 5, radiation from a remote radiation source device 100 is provided to an optical system 200. Optical system 200 collects the radiation from radiation source device 100 and outputs a radiation beam. The radiation beam is output from optical system 200 to an optical fibre 300. The radiation beam is transferred by optical fibre 300 from the output of optical system 200 to the position in scatterometer SM where it is required for performing inspection and/or measurement processes.

Radiation source device 100 may include any suitable source of radiation. For example, radiation source device 100 may include a gas discharge radiation source, such as a Xe or Hg lamp. Typically, a gas discharge lamp with a power output of 75-100 W may be used. A radiation source in radiation source device 100 may have a rectangular shaped arc with dimensions of, for example, 1 mm×0.5 mm. A commercially available gas discharge lamp, such as those produced and/or used by: LINOS Photonics GmbH & Co. KG of Germany; Hamamatsu Photonics Deutschland GmbH of Germany; or USHIO Europe B.V. of the Netherlands would be suitable for use in radiation source device 100.

The radiation output from such a radiation source may, however, not be uniform. For example, properties of the radiation may vary over time. For example, variations in the properties of the radiation produced by radiation source device 100 over time may be a result of sputtering from electrodes in radiation source device 100. Variations in the properties of the radiation produced by radiation source device 100 can lead to variations in the properties (such as intensity and/or distribution) and/or position of the resulting radiation beam that is output from optical system 200 to optical fibre 300.

One particular problem that can result from non-uniformity over time of the radiation output from radiation source device 100 is that of positional instability of the resulting radiation beam. In particular, in metrology device 50 shown in FIG. 5, the position of the radiation beam output from optical system 200 into the input of optical fibre 300 can vary over time. Any variation in position of the radiation beam at the input to optical fibre 300 can result in variation in the properties of the radiation beam that is used in scatterometer SM for the measurement/inspection processes. For example, any variation in the position of the radiation beam at the input to optical fibre 300 can lead to variation in intensity and/or uniformity of the radiation beam that is used in the measurement and/or inspection processes. Such variation in the properties of the radiation can lead to unreliable inspection and/or measurement results.

Embodiments of the present invention provide a control system to control the position of the radiation beam that is output from optical system 200 into optical fibre 300. The control system provided by an embodiment of the present invention can be used, for example, to improve the consistency of the position of the radiation beam at the inlet to optical fibre 300. The control system provided by an embodiment of the present invention can be used, for example, to ensure that the position of the radiation beam relative to the inlet of the optical fibre is always constant, or at least more constant than it would be in the absence of the control system.

An embodiment of an optical system 200 for directing radiation produced from radiation source device 100 into optical fibre 300 is shown in FIG. 6. Optical system 200 shown in FIG. 6 includes a control system for controlling the output position of the radiation beam from optical system 200. FIG. 6 also shows radiation source device 100 and a part of optical fibre 300.

According to the embodiment shown in FIG. 6, the control system includes a deformable mirror 210, a detector 220, and a controller 230.

Deformable mirror 210 may be any suitable deformable mirror. For example, in an embodiment a piezoelectric driven tip-tilt mirror may be used. In another embodiment, a membrane mirror is used. In other embodiments, the deformable mirror may be replaced by any other suitable adaptive optical element, which may be reflective, transmissive, or a combination of reflective and transmissive. However, reflective adaptive optical elements can be advantageous because they are effective over a large range of electromagnetic wavelengths, typically from high ultraviolet wavelengths to low infrared wavelengths. The deformation of deformable mirror 210 shown in FIG. 6 is highly exaggerated compared with typical deformation.

In an embodiment, adaptive optical element 210 has a high response speed to signals 270 provided to adaptive optical element 210 from controller 230.

Detector 220 in an embodiment of FIG. 6 is a quad cell detector array. However, any other suitable detector may be used. For example, any detector that can be used to detect the position of radiation incident upon it may be used. For example, a Hartman-Shack configuration may be used.

As well as detecting the position of radiation incident upon it, detector 220 may also be able to detect the intensity and/or distribution of the radiation incident upon it. Detector 220 according to the embodiment of FIG. 6 is arranged so as to measure the position of the radiation beam in a plane that is normal to the direction of the radiation beam.

As illustrated in FIG. 6, the output from detector 220 is input into controller 230. The output from detector 220 includes four outputs 220a, 220b, 220c, 220d: one from each of the four quadrants of the detector array. Detector 220 can be, for example, any conventional quad cell. Typically, each of the four outputs from the quad cell is a signal that is dependent upon the radiation that is incident on the respective quadrant. For example, each output may be correlated to the intensity and/or position of the radiation incident on the respective quadrant. From the four outputs 220a, 220b, 220c and 220d of detector 220, controller 230 is able to calculate the position of the radiation beam incident upon detector 220.

Controller 230 can then send a signal 270 to deformable mirror 210 based on the position of the radiation incident upon detector 220. Controller 230 may, for example, compare the detected/calculated position of the radiation beam on the detector with a desired position (which may be predetermined) of the radiation beam at detector 220. Signal 270 may then contain information to instruct deformable mirror 210 to adopt a geometry that would result in the radiation beam incident on detector 220 being in the desired position.

As such, a feedback loop, controlled by controller 230, is produced between detector 220 and deformable mirror 210. The response time of deformable mirror 210 may be very quick. In an embodiment, the response time of deformable mirror 210 is at least as quick as a typical time period for variation in the radiation produced by radiation source device 100.

Optical system 200 of the embodiment shown in FIG. 6 also includes a partially reflecting mirror 240. In an embodiment, partially reflecting mirror 240 reflects at least 90% of the radiation incident upon it. In another embodiment, partially reflecting mirror 240 reflects between 95% and 99% of the radiation incident upon it. In still another embodiment, partially reflecting mirror 240 reflects approximately 98% of the radiation incident upon it.

The radiation that is reflected by partially reflecting mirror 240 is output from optical system 200 and provided to input 310 of optical fibre 300. It is this radiation that is transferred by optical fibre 300 and used by scatterometer SM in measurement and/or inspection processes.

The radiation that is transmitted by partially reflecting mirror 240 is directed onto detector 220. It is this radiation that is transmitted by partially reflecting mirror 240 that is subsequently detected by detector 220, and used by controller 230, to provide signal 270 that controls the shape of deformable mirror 210.

The position of the radiation that is transmitted by partially reflecting mirror 240 so as to be incident on detector 220 is related to the position of the radiation that is reflected by partially reflecting mirror 240 and subsequently output from optical system 200 into input 310 of optical fibre 300. Thus, the position of the transmitted radiation, as detected by detector 220 and calculated by controller 230, can be used to determine (and thus control) the position of the radiation that is reflected by partially reflecting mirror 240. As such, control system 210, 220, 230 of optical system 200 uses the portion of the radiation that is transmitted by partially reflecting mirror 240 to control the position of the portion of the radiation that is reflected by partially reflecting mirror 240.

In an embodiment, optical system 200 shown in FIG. 6 also includes two lenses 250, 260.

First lens 250 is placed between radiation source device 100 and deformable mirror 210. As such, first lens 250 is used to collect radiation from radiation source device 100 and direct the radiation onto deformable mirror 210.

Second lens 260 is placed between deformable mirror 210 and partially reflecting mirror 240. A purpose of second lens 260 is to focus the radiation reflected by deformable mirror 210 both into input 310 of optical fibre 300, and onto detector 220. Thus, lens 260 focuses the radiation into a radiation beam to be output from optical system 200 via reflection by partially reflecting mirror 240. Lens 260 also focuses radiation onto detector 220 via transmission by partially reflecting mirror 240.

Typically, the two lenses 250, 260 form an achromatic lens group. Thus the combined optical properties of the two lenses should be independent of the frequency of radiation. However, in some embodiments it is possible to use control signal 270 produced by controller 230 to instruct deformable mirror 210 to adopt a shape that can compensate for any chromatic aberrations of the optical elements (such as the two lenses 250, 260) in the optical system. This may allow less accurate, and thus less expensive, optical elements to be used in optical system 200.

In other embodiments, other lens aberrations may be corrected for by appropriate control of the shape of deformable mirror 210 (or appropriate control of the optical properties of whichever adaptive optical element 210 is used in optical system 200). This can mean that the quality of the optical elements, such as lenses 250, 260, used in optical system 200 can be further reduced.

In the case that a known change in the wavelength of the radiation source is to be introduced, control signal 270 can use feed forward control to control the shape of deformable mirror 210. For example, deformable mirror 210 may adopt a more or less parabolic shape depending on the wavelength of the radiation incident upon it.

Using an embodiment of the present invention to produce a stable radiation beam can obviate the need to incorporate a reference branch into a typical scatterometer, such as that described herein in relation to FIG. 4. In FIG. 4, the reference branch includes reference mirror 14 that is used to project a reference beam onto a detector 18. The reference beam is thus used to measure the intensity of the incident radiation. As explained herein, embodiments of the present invention can be used to control the stability of the incident radiation. Thus, embodiments of the present invention may enable the intensity of the radiation supplied to the scatterometer to be sufficiently stable that the reference branch is not required.

Although the invention has been described in relation to the embodiment shown in FIG. 6, it will be appreciated that various changes may be made to the apparatus and it still be in accordance with an embodiment of the invention. For example, adaptive optical element 210, detector 220 and controller 230 may be arranged in such a way that one or more of partially reflecting mirror 240, first lens 250, and second lens 260 may be omitted. By way of further example, first lens 250 and/or second lens 260 may be relocated, and/or replaced by one or more other lenses. Alternatively or additionally, the arrangement of the elements in optical system 200 shown in FIG. 6 may be changed. In the embodiment shown in FIG. 6, positional control of the radiation beam is provided by the control system including adaptive optical element 210, detector 220, and controller 230.

Optical system 200 and control system 210, 220, 230 for producing a stable radiation beam can be incorporated into a metrology device for use in inspecting and/or measuring properties of a substrate. As such, a metrology device according to an embodiment of the present invention can include radiation source device 100, optical system 200 (described above in relation to FIG. 6), optical fibre 300, and scatterometer SM. Scatterometer SM can be any suitable type of scatterometer, such as those described above in relation to FIGS. 3 and 4. For example, the scatterometer may include a receiver configured to receive radiation that has been transferred by optical fibre 300 and scattered by the substrate being inspected and/or measured, and a processing unit for analyzing the scattered radiation received by the receiver.

The metrology device described herein may also be incorporated into a lithographic apparatus configured to project an image of a pattern onto a substrate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that embodiments of the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A metrology device for inspecting a substrate comprising:
a radiation source;
an optical system configured to form a radiation beam from the radiation source; and
an optical fiber configured to transfer the radiation beam from the output of the optical system to a substrate being inspected,
wherein the optical system comprises a control system to control the position of the radiation beam output therefrom relative to the optical fiber.

2. The metrology device according to claim 1, wherein the control system comprises:
a detector configured to detect a position of at least a portion of the radiation beam and output positional information relating to the position of the radiation;
an adaptive optical element placed in the path of the radiation beam between the radiation source and the detector; and
a controller, wherein the controller is configured to:
receive the positional information from the detector; and
provide a control signal to the adaptive optical element based on the positional information, the optical properties of the adaptive optical element being dependant on the control signal, and the output position of the radiation beam being dependent on the optical properties of the adaptive optical element.

3. The metrology device according to claim 2, wherein the adaptive optical element is configured to change shape in response to the control signal, thereby altering its optical properties.

4. The metrology device according to claim 2, wherein the adaptive optical element is a deformable mirror configured to reflect the radiation beam, a shape of the deformable mirror being dependent on the control signal.

5. The metrology device according to claim 4, wherein the deformable mirror is a membrane mirror.

6. The metrology device according to claim 4, wherein the deformable mirror is a piezoelectric mirror.

7. The metrology device according to claim 2, wherein the detector is a quad cell.

8. The metrology device according to claim 2, wherein the detector is further configured to detect the intensity distribution of the radiation beam.

9. The metrology device according to claim 2, wherein the optical system further comprises a partially reflecting mirror placed between the adaptive optical element and the detector, the partially reflecting mirror configured to reflect a portion of the radiation incident on it, and transmit the rest of the radiation incident on it, wherein the detector is positioned to receive the radiation that is transmitted by the partially reflecting mirror.

10. The metrology device according to claim 9, wherein the portion of radiation that is reflected by the partially reflecting mirror is between 95% and 99%.

11. The metrology device according to claim 2, wherein the detector is configured to detect the position of the radiation beam in a plane normal to the radiation beam.

12. The metrology device according to claim 1, wherein the radiation source is a gas discharge radiation source.

13. The metrology device according to claim 9, wherein:
the partially reflecting mirror is configured to direct the reflected radiation to an output of the radiation supply device; and
the position of the radiation that is detected by the detector is related to the position of the radiation at the output of the optical system.

14. The metrology device according to claim 9, wherein the optical system further comprises:
a first lens configured to direct the radiation from the radiation source onto the adaptive optical element; and
a second lens positioned between the adaptive optical element and the partially reflecting mirror, the second lens configured to focus radiation, via the partially reflecting mirror, onto the detector and to the output of the optical system.

15. The metrology device according to claim 1, further comprising:
a receiver configured to receive radiation originating from the radiation source and transferred to the substrate by the optical fiber that has been scattered by the substrate; and a processing unit for analyzing the scattered radiation received by the receiver.

16. A lithographic apparatus comprising:
an illumination optical system arranged to illuminate a pattern;
a projection optical system arranged to project an image of the pattern on to a substrate; and
a metrology device comprising,
a radiation source;
an optical system configured to form a radiation beam from the radiation source; and
an optical fiber configured to transfer the radiation beam from the output of the optical system to a substrate being inspected,
wherein the optical system comprises a control system to control the position of the radiation beam output therefrom relative to the optical fiber.

17. A method of providing a radiation beam for inspecting a substrate comprising:
providing radiation from a radiation source;
forming a radiation beam from the radiation using an optical system;
transferring the radiation beam from an output of the optical system to a substrate to be inspected using an optical fiber; and
controlling the position of the radiation beam at the output from the optical system relative to the optical fiber.

18. The method of providing a radiation beam for inspecting a substrate according to claim 17, wherein the controlling the position of the radiation beam at the output from the optical system relative to the optical fiber comprises:
directing the radiation beam onto an adaptive optical element;
providing at least a portion of the radiation beam to a detector;
detecting a position of the at least a portion of the radiation beam at the detector; and
controlling the optical properties of the adaptive optical element in response to the detected position so as to control the position of the radiation beam at the output of the optical system relative to the optical fiber.

19. The method of claim 17 further comprising:
irradiating the substrate being inspected using the radiation transferred to the substrate by the optical fiber;
receiving radiation that has been scattered by the substrate being inspected; and
analyzing the received scattered radiation.
